(19) United States
(12) Patent Application Publication
(10) Pub. No.: US 2022/0023956 A1
(43) Pub. Date: Jan. 27, 2022

(54) POWER TURRET DEVICE

(71) Applicant: YU-HONG TECHNOLOGY CO., LTD., KAOHSIUNG CITY (TW)

(72) Inventor: SHENG-FANG TSAI, KAOHSIUNG CITY (TW)

(21) Appl. No.: 16/939,506

(22) Filed: Jul. 27, 2020

(51) Int. Cl. B23B 29/32; B23P 23/02

(52) U.S. Cl. CPC B23B 29/32; B23P 23/02

(57) ABSTRACT

A power turret device includes a turret set on which processing tools are disposed, a transmission gear set disposed in the turret set, an inner axle penetrating through the turret set, a clutch set disposed on the turret set and including first and second engagement units, and a driving set. The turret set includes a base and a turret portion having a head and a support shaft integrated with the head. The integration of the head and the support shaft facilitates the replacement of the turret portion and distributes the weight of the turret portion evenly to prevent undue wear. The turret portion rotates to move any selected processing tool to a proper processing position when the engagement units are separated. The engagement between the engagement units allows the selected processing tool to rotate on its axis. The processing accuracy is increased and the service life is prolonged.

### BACKGROUND OF THIS INVENTION

### 1. Field of this invention

This invention relates to a turret device and relates particularly to a power turret device adapted to be disposed on a workpiece processing assembly with multiple working operations.

### 2. Description of the Related Art

Referring to FIG. 1 and FIG. 2, a conventional workpiece processing assembly 1 comprises a working platform 11, a power turret device 12 disposed on the working platform 11, and a positioning device 13 situated relative to the power turret device 12. The positioning device 13 is adapted to clamp a workpiece 2. The power turret device 12 includes a base 121, a turret head 122 attached to the base 121 and protruding outwards from the base 121, an outer axle 123 penetrating through the base 121 and connected to the turret head 122, a meshing unit 124 disposed between the base 121 and the turret head 122, a transmission gear set 125 disposed in the turret head 122, an inner axle 126 penetrating through the outer axle 123 and connected to the turret head 122 via the transmission gear set 125, a first power source 127 adapted to trigger a rotation of the outer axle 123, and a second power source 128 adapted to trigger a rotation of the inner axle 126. The turret head 122 is formed with a plurality of accommodation holes 1221 adapted to carry a plurality of processing tools 129 respectively.

Referring to FIG. 2, after the meshing unit 124 moves toward the turret head 122, the first power source 127 actuates a rotation of the outer axle 123. The outer axle 123 then transmits power of the first power source 127 to the turret head 122 for carrying out a rotation of the turret head 122 and moving a selected processing tool 129 to a proper processing position. Referring to FIG. 3, the meshing unit 124 then moves toward the base 121 to thereby fix the turret head 122. The second power source 128 then actuates a rotation of the inner axle 126. The inner axle 126 further transmits power of the second power source 128 to the transmission gear set 125 for triggering the selected processing tool 129 to rotate on its axis. Thus different working operations can be executed.

However, the turret head 122 is weighty since it has a certain weight. Simultaneously, the processing tools 129 also weight on the turret head 122. In addition, the turret head 122 is only attached to a front end of the outer axle 123, and that causes the turret head 122 is not properly supported. Hence, during the working operations, the connection part of the turret head 122 and the outer axle 123 will be easily worn out owing to the large weight of the turret head 122 caused by the gravity to result in the displacement of the turret head 122. The turret head 122 is unable to be attached to the base 121 precisely. Meanwhile, the turret head 122 is unable to situate the processing tools 129 accurately. Moreover, the turret head 122 will tremble during the working operations, and that reduces the processing accuracy of the workpiece 2, shortens the service life of the power turret device 12, and reduces the processing effect. Further, when replacing the unduly worn turret head 122, the turret head 122 should be removed and relative fixing units (not shown) should be replaced simultaneously, and that complicates the replacement of the turret head 122. Hence, the replacement of the turret head 122 becomes laborious and time consuming. The maintenance cost is also increased, and that requires to 3 e improved.

### SUMMARY OF THIS INVENTION

The object of this invention is to provide a power turret device capable of supporting a turret portion stably, preventing undue wear of the turret portion, increasing the processing accuracy effectively, prolonging the service life, and attaining the preferable processing effect.

The power turret device of this invention includes a turret set, a plurality of processing tools disposed on the turret set, a transmission gear set disposed in the turret set, an inner axle threading through the turret set and connected to the transmission gear set, a clutch set disposed on the turret set, and a driving set for supplying power. The turret set has a base, a turret portion disposed in the base, and a plurality of accommodation holes formed on the turret portion for accommodating the processing tools. The turret portion has a head and a support shaft extending outwards from the head. The head is integrated with the support shaft. The clutch set has a first engagement unit disposed on the base and a second engagement unit disposed on the head. The first engagement unit and the second engagement unit are located corresponding to each other. The driving set has a first power source adapted to trigger a rotation of the turret portion and a second power source connected to the inner axle and adapted to trigger an operation of the processing tools via the transmission gear set. When the second engagement unit is separated from the first engagement unit, the turret portion is actuated by the first power source to rotate and move any selected processing tool to a proper processing position. When the turret portion moves toward the base to engage the second engagement unit with the first engagement unit, the turret portion is fixed and the inner axle is actuated by the second power source to thereby rotate the selected processing tool on its axis via the transmission gear set. Thus, different working operations can be executed. Further, the integration of the head and the support shaft facilitates the replacement of the turret portion and distributes the weight of the turret portion evenly to the head and the support shaft. Meanwhile, the head is supported stably when the support shaft penetrates through the base to thereby prevent the turret portion from being worn out unduly, increase the processing accuracy, extend the service life, and attain the preferable processing effect.

Preferably, at least one bearing is sleevedly disposed around the support shaft.

### BRIEF DESCRIPTION OF THE DRAWINGS

FIG. 1 is a schematic view showing a conventional workpiece processing assembly;

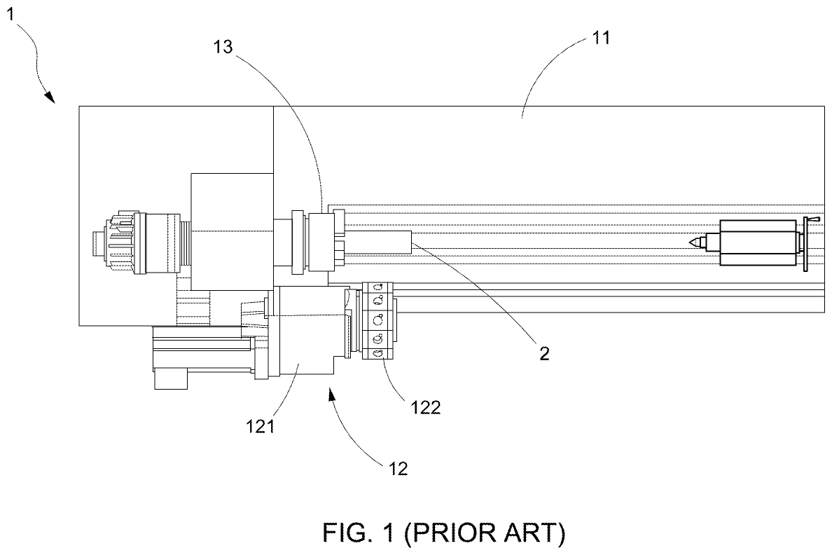

FIG. 2 is a schematic view showing that the turret head is not fixed;

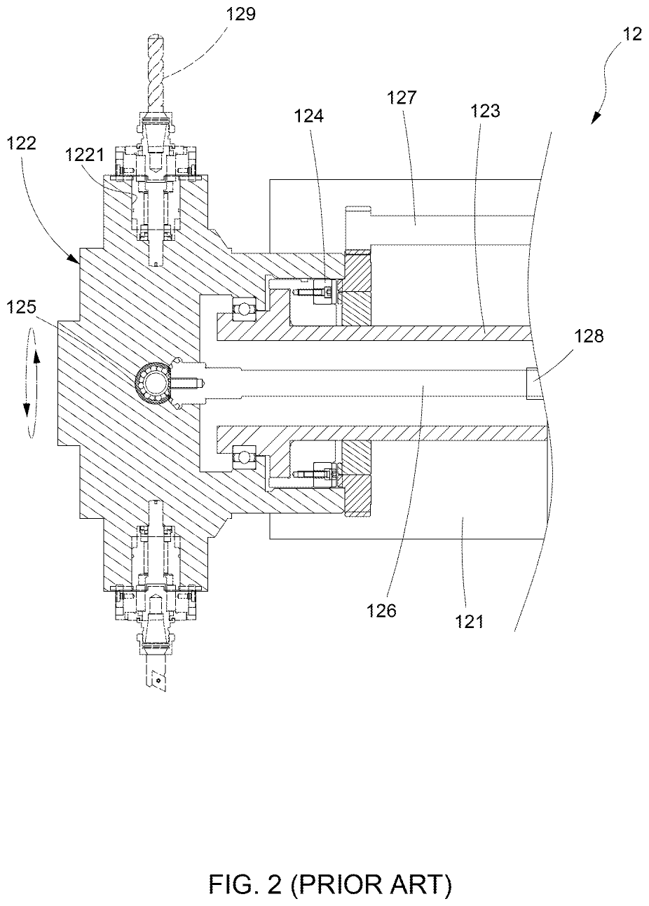

FIG. 3 is a schematic view showing that the turret head is fixed;

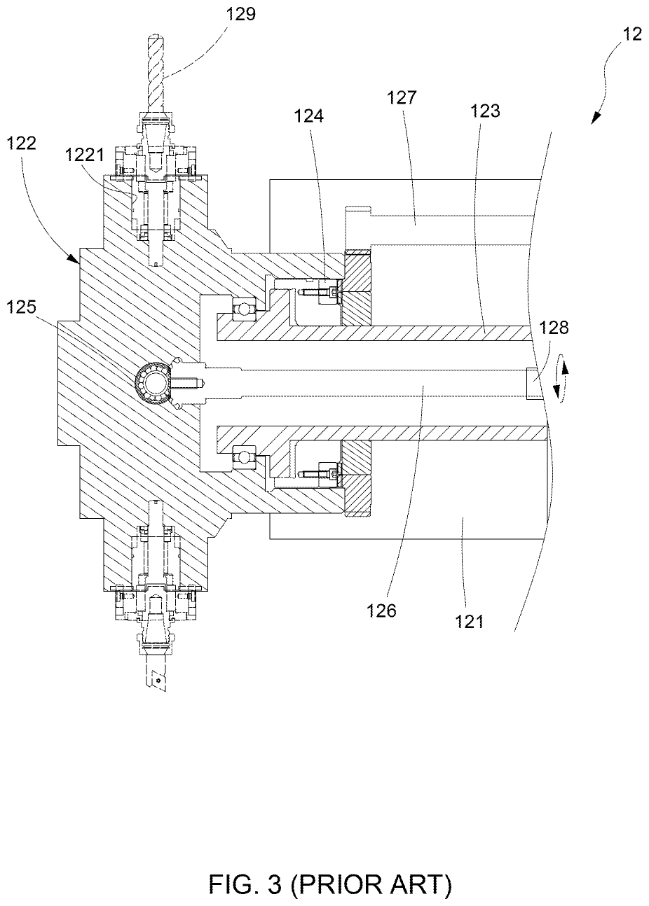

FIG. 4 is a perspective view showing a first preferred embodiment of this invention;

FIG. 5 is a top plan view of the first preferred embodiment of this invention;

FIG. 6 is a cross-sectional view showing that the second engagement unit is separated from the first engagement unit;

FIG. 7 is a cross-sectional view showing that the second engagement unit is engaged with the first engagement unit; and

FIG. 8 is a cross-sectional view of the first preferred embodiment of this invention.

### DETAILED DESCRIPTION OF THE PREFERRED EMBODIMENTS

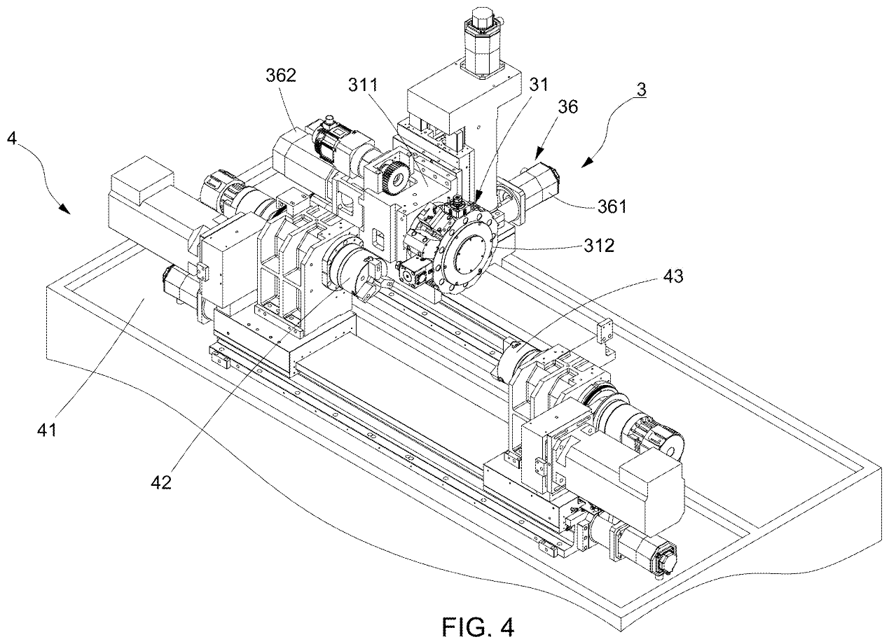

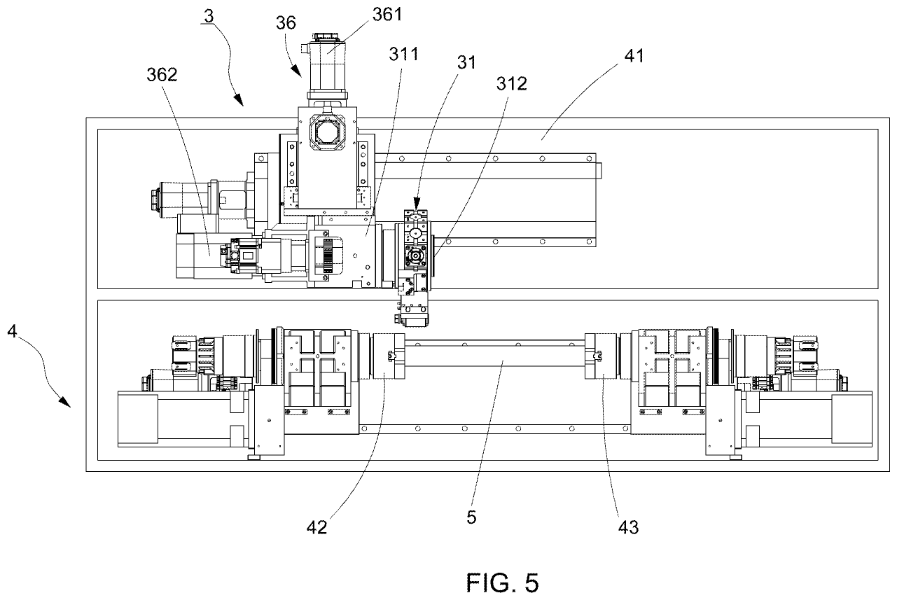

Referring to FIG. 4 and FIG. 5, a power turret device 3 of a first preferred embodiment of this invention is adapted to be disposed on a workpiece processing assembly 4. The workpiece processing assembly 4 is capable of executing multiple working operations and includes a working platform 41 on which the power turret device 3 is disposed, a positioning device 42 disposed on the working platform 41 and adapted to clamp at least one workpiece 5 to be processed, and an auxiliary device 43 located relative to the positioning device 42. In this preferred embodiment, the positioning device 42 and the auxiliary device 43 are adapted to clamp two ends of the same workpiece 5 respectively. Alternatively, the positioning device 42 and the auxiliary device 43 can also be adapted to clamp different workpieces 5.

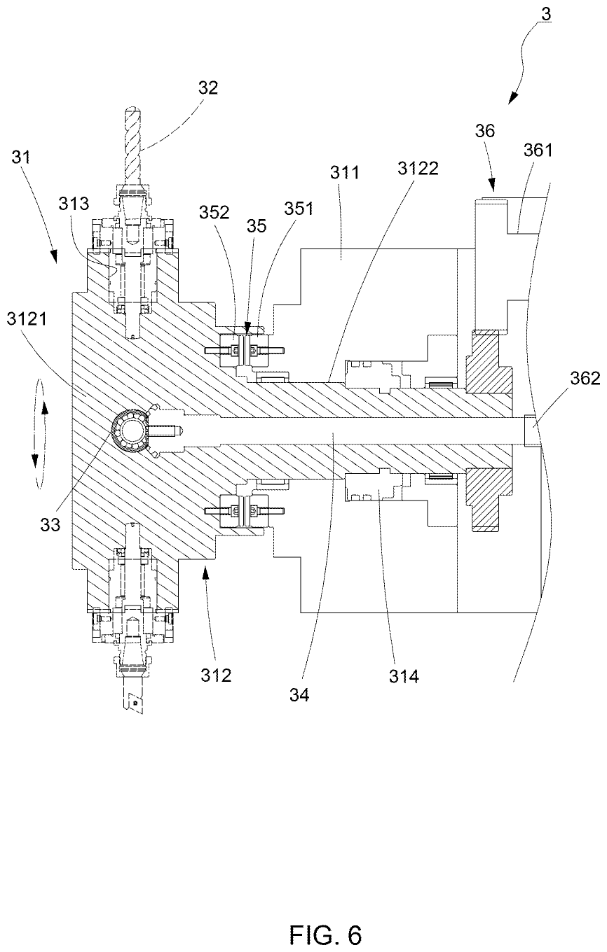

Referring to FIG. 6, the power turret device 3 comprises a turret set 31, a plurality of processing tools 32 installed on the turret set 31, a transmission gear set 33 disposed in the turret set 31, an inner axle 34 threading through the turret set 31 and connected to the transmission gear set 33, a clutch set 35 disposed on the turret set 31, and a driving set 36 for supplying power. The turret set 31 includes a base 311, a turret portion 312 attached to the base 311, and a plurality of accommodation holes 313 formed on the turret portion 312. The turret portion 312 has a head 3121 and a support shaft 3122 extending outwards from the head 3121. The head 3121 is integrated with the support shaft 3122. Each processing tool 32 is held in the accommodation hole 313 in position. The transmission gear set 33 is disposed in the head 3121 and adapted to trigger an operation of the processing tools 32 which serve to turn the workpiece 5. The inner axle 34 penetrates through the support shaft 3122 to connect with the head 3121 via the transmission gear set 33. In this preferred embodiment, at least one bearing 314 is sleevedly disposed around the support shaft 3122. The clutch set 35 includes a first engagement unit 351 disposed on the base 311 and a second engagement unit 352 disposed on a periphery of the head 3121. The first engagement unit 351 and the second engagement unit 352 are situated corresponding to each other. The driving set 36 includes a first power source 361 disposed on the workpiece processing assembly 4 and adapted to trigger a rotation of the turret portion 312 and a second power source 362 connected to the inner axle 34 and adapted to trigger a rotation of the processing tools 32.

Referring to FIG. 5 and FIG. 6, during the working operations, the positioning device 42 is adapted to clamp one end of the workpiece 5. The auxiliary device 43 is then actuated to move toward the positioning device 42 to thereby adjust the distance between the positioning device 42 and the auxiliary device 43 and clamp another end of the workpiece 5 when the workpiece 5 has a large length or size. Thus, the workpiece 5 to be processed is fixed between the positioning device 42 and the auxiliary device 43 stably. Referring to FIG. 6, the turret portion 312 then moves toward a direction opposite to the base 311 to separate the second engagement unit 352 from the first engagement unit 351. Meanwhile, the bearing 314 is also separated from the base 311 caused by the movement of the turret portion 312. Thus, the turret portion 312 is not fixed to the base 311. After that, the turret portion 312 is actuated by the first power source 361 to rotate and move a selected processing tool 32 to a proper processing position for processing the workpiece 5, namely the selected processing tool 32 is situated to face the workpiece 5.

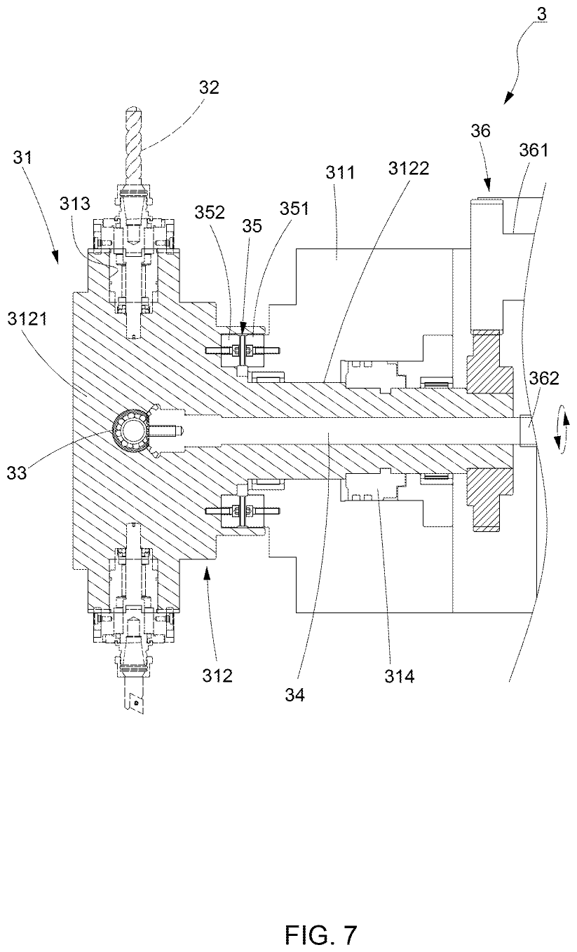

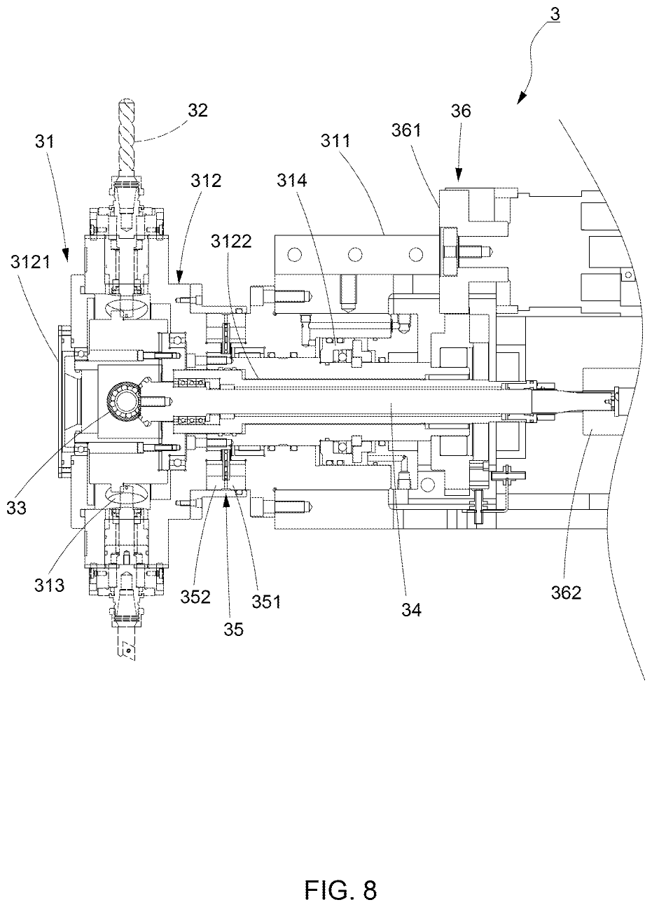

Referring to FIG. 7 and FIG. 8, after the selected processing tool 32 is positioned at the proper processing position for processing the workpiece 5, the turret portion 312 moves toward the base 311 to engage the second engagement unit 352 with the first engagement unit 351. Meanwhile, the bearing 314 is also engaged with the base 311 to thereby fix the turret portion 312 to the base 311 stably. After that, the inner axle 34 is actuated by the second power source 362 to rotate. The inner axle 34 then transmits power of the second power source 362 to the transmission gear set 33 to thereby carry out a rotation of the selected processing tool 32 via the transmission gear set 33. Thus, the selected processing tool 32 can rotate on its axis to execute the turning process of the workpiece 5. Hence, the engagement between the second engagement unit 352 and the first engagement unit 351 helps fix the turret portion 312 stably. Thus, the selected processing tool 32 can be triggered by the second power source 362 to rotate on its axis and process the workpiece 5. On the contrary, when the second engagement unit 352 and the first engagement unit 351 are separated, the turret portion 312 is loosened, and that allows the first power source 361 to carry out a rotation of the turret portion 312 and move the selected processing tool 32 to the proper processing position. Therefore, different working operations can be completed. Further, the integration of the head 3121 and the support shaft 3122 allows the weight of the turret portion 312 to be distributed evenly. The head 3121 can be held stably when the support shaft 3122 threads through the base 311. Thus, the undue wear of the turret portion 312 is prevented. The turret, portion 312 will not tremble during the working operations to thereby increase the processing accuracy of the workpiece 5, extend the service life, and attain the preferable processing effect. Moreover, the integration of the head 3121 and the support shaft 3122 facilitates the replacement of the turret portion 312. The replacement of the turret portion 312 is executed by taking the turret portion 312 including the head 3121 and the support shaft 3122 outwards, and penetrating new turret portion 312 into the base 311 through the support shaft 3122. Hence, the replacement of the turret portion 312 is simple, labor-saving, and time-saving.

To sum up, the power turret device of this invention takes an advantage that the head is integrated with the support shaft to form the turret portion to distribute the weight of the turret portion evenly and support the head stably when the support shaft threads through the base to thereby prevent the undue wear of the turret portion effectively, ensure the preferable processing accuracy of the workpiece, prolong the service life, and attain the preferable processing effect. Meanwhile, the integration of the head and the support shaft also facilities the replacement of the turret portion to allow the replacement to be simple, labor-saving and time-saving. Further, the turret portion rotates to move the selected processing tool to a proper processing position when the first engagement unit and the second engagement unit are separated. The engagement between the first engagement unit and the second engagement unit allows the selected processing tool to rotate on its axis to thereby complete different working operations.

While the embodiments of this invention are shown and describe it is understood that further variations and modifications may be made without departing from the scope of this invention.

What is claimed is:

1. A power turret device adapted to be disposed on a working platform of a workpiece processing assembly, said power turret device comprising:
a turret set including a base, a turret portion attached to said base, and a plurality of accommodation holes formed on said turret portion, wherein said turret portion has a head and a support shaft extending outwards from said head, said head being integrated with said support shaft, said support shaft penetrating through said base when said turret portion is installed on said base;
a plurality of processing tools respectively held in said plurality of accommodation holes in position;
a transmission gear set disposed in said head of said turret portion and adapted to trigger an operation of said plurality of processing tools;
an inner axle penetrating through said support shaft and, connected to said head via said transmission gear set;
a clutch set including a first engagement unit disposed on said base and a second engagement unit disposed on a periphery of said head, said first engagement unit and said second engagement unit being located corresponding to each other, said second engagement unit engaging with said first engagement unit when said turret portion moves toward said base to thereby fix said turret portion; and
a driving set including a first power source disposed on said workpiece processing assembly and adapted to trigger a rotation of said turret portion and a second power source connected to said inner axle, said inner axle transmitting power of said second power source to said transmission gear set for triggering an operation of said plurality of processing tools.

2. The power turret device according to claim 1, further comprising at least one bearing sleevedly disposed around said support shaft.
